(19) United States
(12) Patent Application Publication
(10) Pub. No.: US 2025/0211086 A1
(43) Pub. Date: Jun. 26, 2025

(54) Power Converter, Primary-Side Controller, Secondary-Side Controller, and Related Control Method Capable of Operating in Standby Mode

(71) Applicant: Weltrend Semiconductor Inc., Hsinchu (TW)

(72) Inventors: Jeng-Cheng LIU, Hsinchu (TW); Ren-Yi CHEN, Hsinchu (TW)

(21) Appl. No.: 18/909,122

(22) Filed: Oct. 8, 2024

(30) Foreign Application Priority Data
Dec. 21, 2023 (TW) 112150103

(51) Int. Cl. H02M 1/00; H02J 9/00; H02M 1/08; H02M 7/04

(52) U.S. Cl. CPC H02M 1/0035; H02M 1/0009; H02M 1/08; H02M 7/043; H02J 9/007

(57) ABSTRACT

An embodiment of the invention discloses a method for powering down a power converter with a photo coupler. Responsive to disconnection of a load from the power converter, the power converter is placed into a standby mode, during which a LED current flowing through the LED of the photo coupler is switched a predetermined number of times at each predetermined period, where the predetermined number is at least once.

### CROSS-REFERENCE TO RELATED APPLICATION

This application claims priority to and the benefit of Taiwan Application Series Number 112150103 filed on Dec. 21, 2023, which is incorporated by reference in its entirety.

### BACKGROUND

The present disclosure relates generally to a standby mode at which a power converter operates when disconnection of a load is detected, and more particularly, apparatuses and control methods for a power converter which largely reduces a LED current through a photo coupler during the standby mode.

Due to its simple structure, a flyback converter is often used as the fundamental architecture for battery chargers in portable electronic devices. The flyback converter features a feedback loop to regulate an output voltage that supplies power to a load, such as a rechargeable battery for portable electronic devices. When charging a rechargeable battery, a flyback converter operates in a normal mode; when the rechargeable battery is disconnected from the flyback converter, the converter operates in a standby mode. In the normal mode, the feedback loop typically includes an error amplifier, which generates an error signal based on the difference between the output voltage of the flyback converter and a desired target voltage. This error signal is then low-pass filtered by a loop filter to produce a compensation signal, which can be used to control a power switch in the flyback converter responsible for determining energy transfer. In the standby mode, the feedback loop still needs to be active to stabilize the output voltage. As a result, the flyback converter continues to consume power in the standby mode, and this consumed power is often referred to as standby power or standby loss.

To reduce standby power, one approach is to lower the power consumption of the integrated circuit (IC) that controls the power switch. In a standby mode, when the compensation signal indicates that the load is very light or even absent, many functional blocks within the IC can be turned OFF to reduce the current consumption. However, even with this approach, the feedback loop still needs to remain active to monitor and control the output voltage. This is particularly true when the feedback loop generates the compensation signal through an photocoupler. The power required to keep the photocoupler operational often constitutes the majority of the standby power.

U.S. Pat. No. 11,527,962 introduces operations for a standby mode, in which the photocoupler is mostly turned OFF, and is only activated to signal a primary-side controller to perform power conversion when the output voltage drops below a certain level.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified. These drawings are not necessarily drawn to scale. Likewise, the relative sizes of elements illustrated by the drawings may differ from the relative sizes depicted.

The invention can be more fully understood by the subsequent detailed description and examples with references made to the accompanying drawings, wherein:

FIG. 1 illustrates a power converter implemented according to the present invention;

FIG. 2 shows the state diagram of the operation states for a primary-side controller and a secondary-side controller;

FIG. 3 shows a primary-side controller according to the present invention; and

FIG. 4 illustrates a secondary-side controller according to the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure, or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures, or characteristics may be combined in any suitable combinations and/or subcombinations in one or more embodiments or examples. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

According to an embodiment of the present invention, a power converter i primary-side controller and a secondary-side controller. When supplying power to a load, the power converter operates in a normal mode. When the secondary-side controller detects that the load is disconnected from the power converter, the power converter can operate in a standby mode. Upon detecting that the load is disconnected from the power converter, the secondary-side controller transmits a no-load message to the primary-side controller by regulating the output voltage of the power converter. Subsequently, the secondary-side controller receives a confirmation message from the primary-side controller by monitoring the output voltage, and then allows the power converter to operate in the standby mode.

In one embodiment, during the standby mode, the primary-side controller and the secondary-side controller operate in a guarding state and a deep-burst state, respectively. In the deep-burst state, the secondary-side controller briefly supplies LED current to the light-emitting diode (LED) of a photocoupler after a prolonged period of turning OFF the LED current. In the guarding state, the primary-side controller switches a power switch a predetermined number of times—at least once—when it detects a fluctuation in a compensation signal controlled by the photocoupler.

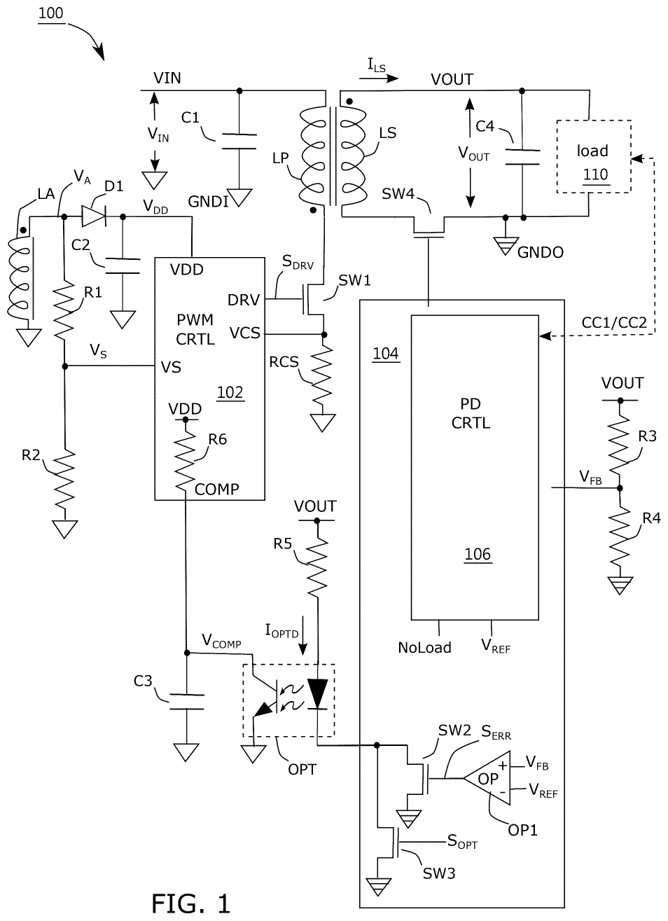

FIG. 1 illustrates power converter 100 implemented according to the present invention, as an example, having a flyback topology. The invention is not limited to flyback converters and can also be applied to power converters with other configurations. Input voltage V_{IN} may be a DC voltage across input capacitor C1 or across the input power line VIN and input ground line GNDI, and could be generated from AC mains power through full-wave rectification. Power converter 100 is used to convert input voltage V_{IN} on the primary side into output voltage V_{OUT} on the secondary side. Output voltage V_{OUT} is stored in output capacitor C4 and is present across output power line VOUT and output ground line GNDO. As shown in FIG. 1, the primary side is galvanically isolated from the secondary side.

Primary-side controller 102 could be a pulse-width modulation (PWM) integrated circuit (IC) that provides control signal S_{DRV} to regulate the switching cycles of power switch SW1. Input voltage V_{IN} supplies energy stored in primary winding LP, and the energy can be transferred through secondary winding LS to generate secondary-side current I_{LS} that charges output capacitor C4, thus establishing output voltage V_{OUT}. Primary winding LP, secondary winding LS, and auxiliary winding LA can be three windings in a transformer that are inductively coupled to each other. Secondary-side controller 104, a synchronous rectifier controller for example, can control synchronous rectification (SR) switch SW4 to rectify secondary-side current I_{LS}.

A voltage divider composed of resistors R3 and R4 provides feedback voltage V_{FB}, which can be considered a scaled-down version of output voltage V_{OUT}. Secondary-side controller 104 includes differential amplifier OP1 that generates control signal S_{ERR} based on the difference between feedback voltage V_{FB} and reference voltage V_{REF}. Since feedback voltage V_{FB} is a scaled-down version of output voltage V_{OUT}, differential amplifier OP1 equivalently generates control signal S_{ERR} based on the difference between output voltage V_{OUT} and target voltage V_{TAR} (which is proportional to reference voltage V_{REF}). Controlling switch SW2, control signal S_{ERR} adjusts LED current I_{OPTD} flowing through the light-emitting diode (LED) in photocoupler OPT.

Corresponding to LED current I_{OPTD}, photocoupler OPT generates a current on the primary side, which, after low-pass filtering by the loop filter with resistor R6 and compensation capacitor C3, produces compensation signal V_{COMP}. Primary-side controller 102 regulates the switching cycles of power switch SW1 based on compensation signal V_{COMP}. For example, the higher compensation signal V_{COMP}, the higher the switching frequency and duty cycle of power switch SW1, allowing more power from input voltage V_{IN} to be stored in primary winding LP.

Thus, the combination of resistors R3 and R4, differential amplifier OP1, photocoupler OPT, compensation capacitor C3, primary-side controller 102, power switch SW1, primary winding LP, secondary winding LS, and output capacitor C4 can be regarded as a feedback loop that regulates output voltage V_{OUT} to target voltage V_{TAR}.

When secondary-side current I_{LS} from secondary winding LS charges output capacitor C4, winding voltage V_{A} of auxiliary winding LA can be considered a reflected signal that mirrors output voltage V_{OUT}. Reflected signal V_{S} in FIG. 1 is the result from a voltage divider formed by resistors R1 and R2, which proportionally divides winding voltage V_{A}. Therefore, reflected signal V_{S} can represent output voltage V_{OUT}. Primary-side controller 102 can sense output voltage V_{OUT} by detecting reflected signal V_{S}.

In one embodiment, power converter 100 includes a USB type-C interface, where Power Delivery (PD) controller 106 within secondary-side controller 104 functions as a load detector. It uses configuration channels CC1/CC2 in the interface to determine whether load 110 is connected to the USB type-C interface. Based on this detection, it can generate signal NoLoad and determines reference voltage V_{REF}, which sets target voltage V_{TAR}.

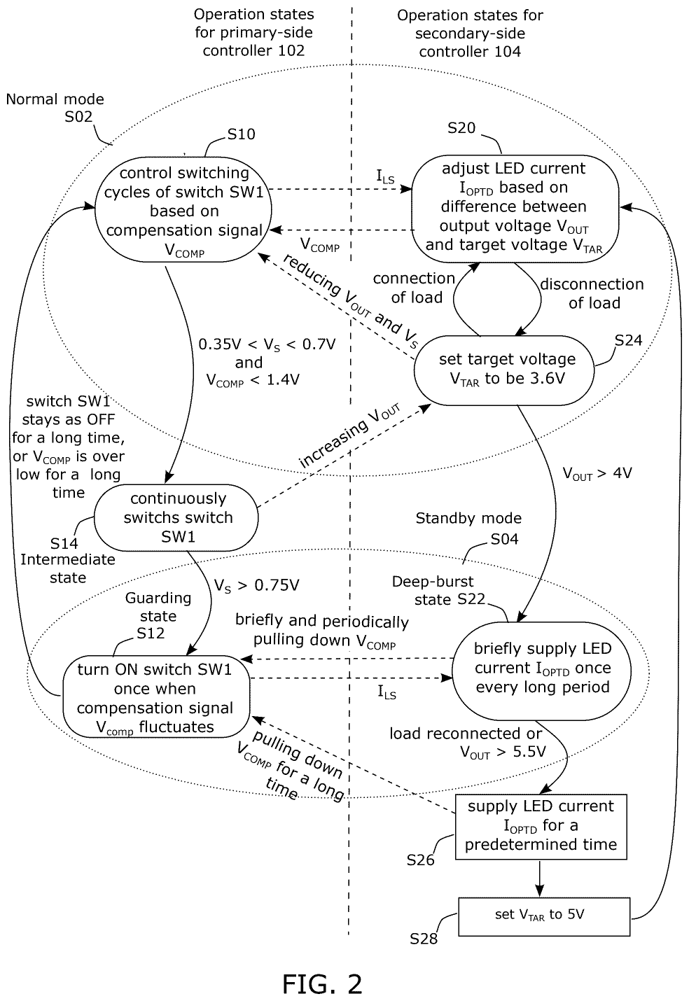

FIG. 2 shows the state diagram of the operation states for primary-side controller 102 and secondary-side controller 104. When PD controller 106 detects that load 110 is connected to power converter 100, power converter 100 can operate in normal mode S02, utilizing the feedback loop in FIG. 1 to regulate output voltage V_{OUT}. In normal mode S02, primary-side controller 102 and secondary-side controller 104 could operate respectively in power modulation state S10 and output-voltage feedback state S20.

In output-voltage feedback state S20, PD controller 106 controls the feedback loop by determining target voltage V_{TAR}. Differential amplifier OP1 compares output voltage V_{OUT} with target voltage V_{TAR}, generating control signal S_{EER}, which controls LED current I_{OPTD}, effectively controlling compensation signal V_{COMP} on the primary side. In power modulation state S10, primary-side controller 102 controls the switching cycles of power switch SW1 based on compensation signal V_{COMP}, which approximately determines secondary-side current I_{LS} that charges output capacitor C4. These two states, S10 and S20, work together to keep the feedback loop active, ensuring that output voltage V_{OUT} is stabilized at target voltage V_{TAR}.

In normal mode S02, switch SW3, which is used to control LED current I_{OPTD}, remains in an OFF state.

When PD controller 106 detects that load 110 has disconnected from power converter 100, power converter 100 could operate in standby mode S04, where primary-side controller 102 and secondary-side controller 104 respectively operate in guarding state S12 and deep-burst state S22. In standby mode S04, power consumption of the feedback loop is reduced, or the feedback loop is powered down. For example, PD controller 106 can disable differential amplifier OP1 to conserve power, keep switch SW2 OFF, and primary-side controller 102 shuts down the functionality that determines the ON-time and switching frequency of power switch SW1 based on compensation capacitor V_{COMP}.

In deep-burst state S22, secondary-side controller 104 keeps switch SW2 consistently OFF and, at a preset fixed frequency, controls switch SW3 via signal S_{OPT} to switch LED current I_{OPTD} flowing through photocoupler OPT a predetermined number of times, with this number being at least once. For example, at a fixed frequency of 20 Hz (every 50 ms), secondary-side controller 104 only turns ON switch SW3 once, each time for approximately 200 μs. As a result, compensation signal V_{COMP} on the primary side will also be periodically pulled low by photocoupler OPT briefly (for about 200 μs) every 50 ms. Compared to output-voltage feedback state S20, deep-burst state S22 consumes much less power because the power consumption of the photocoupler OPT is significantly reduced.

During guarding state S12, primary-side controller 102 monitors compensation signal V_{COMP} for changes. When it detects a fluctuation in compensation signal V_{COMP}, primary-side controller 102 turns ON power switch SW1 a predetermined number of times, with this number being at least once. In one embodiment, when the compensation signal V_{COMP} rises across 1.4V, primary-side controller 102 turns ON power switch SW1 once. This single ON-time of power switch SW1 can be set as a fixed duration, a preset minimum ON time for example, or it lasts until current-sense signal V_{CS} at the current-sense terminal CS reaches a predetermined value (e.g., 0.1V).

During guarding state S12, primary-side controller 102 could also initiate and continue the switching cycles of power switch SW1 when operation voltage V_{DD}, a power source supplying power to primary-side controller 102, seems over low, or less than a predetermined value. It will maintain these switching cycles until operation voltage V_{DD} rises to a predetermined acceptable value. In this way, in standby mode S04, power converter 100 can approximately maintain both operation voltage V_{DD} and output voltage V_{OUT}, preventing them from dropping too low.

In FIG. 2, primary-side controller 102 and secondary-side controller 104 communicate with each other about the impending transition from normal mode S02 to standby mode S04 by controlling output voltage V_{OUT}.

As shown in FIG. 2, during normal mode S02, secondary-side controller 104 might detect that load 110 is no longer connected to power converter 100, and then enters no-load notification state S24, in which PD controller 106 sets target voltage V_{TAR} to be a no-load preset value, for example, 3.6V. This allows secondary-side controller 104 to send primary-side controller 102 a no-load message, indicating the disconnection of load 110. In one embodiment, in output-voltage feedback state S20, target voltage V_{TAR} is typically equal to or greater than 5V. In no-load notification state S24, target voltage V_{TAR} is set to be a lower value of 3.6V, and it is expected that output voltage V_{OUT} is going to decrease and approach 3.6V in the long run.

When operating in power modulation state S10, primary-side controller 102 could detect that output voltage V_{OUT} has dropped below 5V based on reflected signal V_{S}. In one embodiment, when output voltage V_{OUT} is at 3.6V, reflected signal V_{S} falls within a predetermined range of approximately 0.35V to 0.7V. If primary-side controller 102 observes that reflected signal V_{S} has remained within this predetermined range for a very long period, over 50 ms for example, and that compensation signal V_{COMP} continuously indicates a light load condition (V_{COMP}<1.4V), then primary-side controller 102 decides that it is the no-load message sent from the secondary side, and thus transitions into intermediate state S14.

In intermediate state S14, primary-side controller 102 ignores compensation signal V_{COMP} and continuously switches power switch SW1, supplying power to the secondary side, until reflected signal V_{S} exceeds 0.75V, at which point it transitions into guarding state S12. By forcing output voltage V_{OUT} higher, primary-side controller 102 sends a confirmation message to secondary-side controller 104. For example, in intermediate state S14, at a fixed frequency of 33 kHz (every 30 μs), primary-side controller 102 turns ON power switch SW1 once, and the ON time of power switch SW1 is a preset minimum ON-time or is determined by limiting the peak value of current-sense signal V_{CS}. In this manner, both output voltage V_{OUT} and reflected signal V_{S} gradually increase over time. Once reflected signal V_{S} exceeds 0.75V, primary-side controller 102 immediately transitions into guarding state S12, effectively entering standby mode S04.

In no-load notification state S24, according to an embodiment of the invention, target voltage V_{TAR} is set to 3.6V, or output voltage V_{OUT} is featured to be less than 4. However, in intermediate state S14, primary-side controller 102 forces output voltage V_{OUT} to rise. Therefore, when secondary-side controller 104 detects that output voltage V_{OUT} was initially dropping toward 3.6V but after a while was forced by primary-side controller 102 to rise above 4V (a preset response value), it surely receives the confirmation message from primary-side controller 102. The feature that output voltage V_{OUT} is supposed to have during no-load notification state S24 is lost. Consequently, secondary-side controller 104 exits no-load notification state S24 and enters deep-burst state S22, effectively entering standby mode S04.

FIG. 2 also shows how primary-side controller 102 exits standby mode S04. If power switch SW1 has not been turned ON for too long, or compensation signal V_{COMP} stays too low for too long, primary-side controller 102 exits guarding state S12 and returns to normal mode S02. For example, if compensation signal V_{COMP} remains above 1.4V for 700 ms (meaning power switch SW1 has not turned ON for 700 ms), or if compensation signal V_{COMP} stays below 0.5V for more than 10 ms, primary-side controller 102 exits guarding state S12 and enters power modulation state S10.

FIG. 2 also illustrates the conditions for secondary-side controller 104 to exit standby mode S04: at the time when load 110 is detected as being connected to power converter 100, or at the time when output voltage V_{OUT} exceeds 5.5V. In one embodiment, after exiting standby mode S04, secondary-side controller 104 first turns ON switch SW3 for a preset period (step S26), such as 20 ms, then sets target voltage V_{TAR} to 5V (step S28), and afterward, it returns to output-voltage feedback state S20 in normal mode S02.

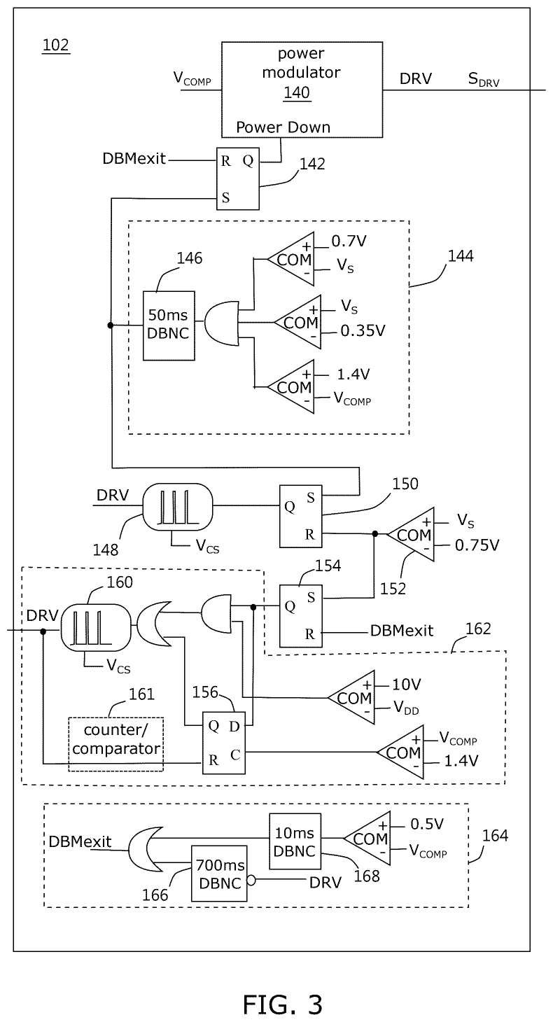

Please refer to FIGS. 2 and 3. FIG. 3, as an example, shows how primary-side controller 102 implements the state diagram related to primary-side controller 102 as depicted in FIG. 2.

Power modulator 140, implementing power modulation state S10, controls the switching cycles of power switch SW1 based on compensation signal V_{COMP}. Standby detector 144 includes three comparators and debouncing apparatus 146. When it detects that reflected signal V_{S} falls between 0.7V and 0.35V, and compensation signal V_{COMP} stays below 1.4V, and both conditions persist for 50 ms, standby detector 144, via SR flip-flop 142, reduces the power consumption of power modulator 140, making primary-side controller 102 exit power modulation state S10. Additionally, through SR flip-flop 150, standby detector 144 transitions primary-side controller 102 into intermediate state S14. After exiting power modulation state S10, power modulator 140 no longer drives power switch SW1. For example, the circuit within power modulator 140 used to detect compensation signal V_{COMP} is shut down to save power, and the driver circuit within power modulator 140 that drives power switch SW1 is also deactivated, meaning power modulator 140 no longer drives power switch SW1.

During intermediate state S14, SR flip-flop 150 activates periodic pulse generator 148 to operate at a switching frequency of 33 kHz and to turn ON power switch SW1 only once every 33 μs. The ON time of the power switch SW1 during each switching cycle (e.g., 33 μs) is either a preset minimum ON time or determined by limiting the peak value of current-sense signal V_{CS}.

During intermediate state S14, once comparator 152 detects that reflected signal V_{S} exceeds 0.75V, it resets SR flip-flop 150, causing primary-side controller 102 to exit intermediate state S14, and stopping periodic pulse generator 148. Simultaneously, comparator 152, via SR flip-flop 154, causes primary-side controller 102 to enter guarding state S12, enabling deep-burst reactor 162 to work.

During guarding state S12, D flip-flop 156 in FIG. 3 enables periodic pulse generator 160 when compensation signal V_{COMP} rises across 1.4V. Periodic pulse generator 160 begins at least one switching cycle of power switch SW1, by generating one or more pulses. When counter/comparator 161 detects that the number of the pulses from periodic pulse generator 160 has reached a predetermined digit, not less than one, it resets D flip-flop 156, disabling periodic pulse generator 160 until the next time when compensation signal V_{COMP} rises across 1.4V. If the predetermined digit is set to just one, counter/comparator 161 can be omitted.

During guarding state S12, deep-burst reactor 162 also prevents operation voltage V_{DD} from over low. As shown in FIG. 3, when operation voltage V_{DD} falls below 10V, periodic pulse generator 160 periodically generates pulses to turn ON and OFF power switch SW1 while D flip-flop 156 could not stop periodic pulse generator 160. Operation voltage V_{DD} supposedly increases as a result until operation voltage V_{DD} becomes not less than 10V. Therefore, operation voltage V_{DD} is prevented from over low.

During guarding state S12, if compensation signal V_{COMP} remains below 0.5V for more than 10 ms (an example determined by debouncer 168) or if power switch SW1 stays OFF for more than 700 ms (an example determined by debouncer 166), escape determiner 164, by resetting SR flip-flop 154, causes primary-side controller 102 to exit guarding state S12 and halt the operation of deep-burst reactor 162. Simultaneously, escape determiner 164, by resetting SR flip-flop 142, also prompts primary-side controller 102 to enter power modulation state S10, resuming power modulator 140.

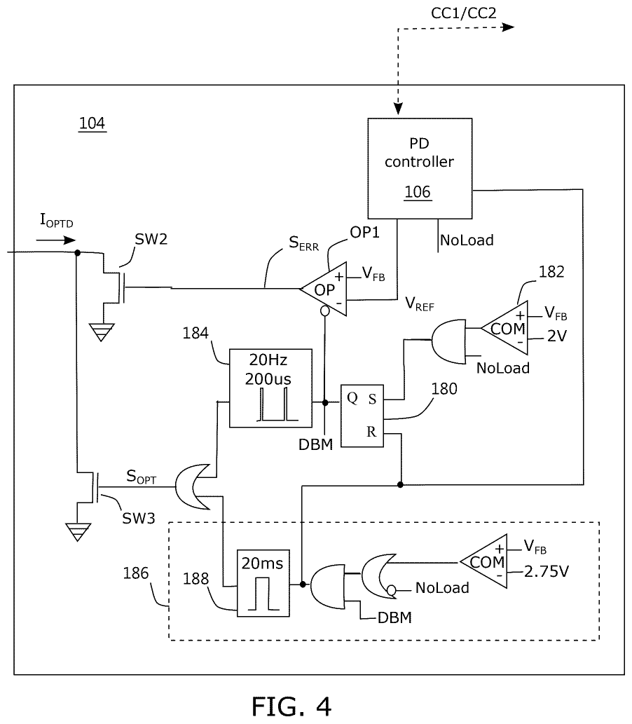

Please refer to FIGS. 2 and 4. FIG. 4, as an example, illustrates how secondary-side controller 104 implements the state diagram related to secondary-side controller 104 as depicted in FIG. 2.

In the embodiment of FIG. 4, target voltage V_{TAR} is twice reference voltage V_{REF}. During output-voltage feedback state S20 in normal mode S02, when load 110 is connected to the USB Type-C interface, PD controller 106 sets signal NoLoad to logic “0” and, through configuration channels CC1/CC2, handshakes with load 110 to determine reference voltage V_{REF}, which is at least 2.5V during output-voltage feedback state S20, making target voltage V_{TAR} greater than 5V. At this moment, standby signal DBM output from SR flip-flop 180 is logic “0”, enabling differential amplifier OP1. Differential amplifier OP1 compares feedback voltage V_{FB} with reference voltage V_{REF} to control LED current I_{OPTD}.

Once it is detected that load 110 is no longer connected to the USB Type-C interface, PD controller 106 sets signal NoLoad to logic “1,” and reference voltage V_{REF} to 1.8V. Since differential amplifier OP1 continues to control LED current I_{OPTD} through switch SW2, feedback voltage V_{FB} will gradually fall and approach 1.8V. At this point, secondary-side controller 104 enters no-load notification state S24.

When feedback voltage V_{FB} drops below 2V and then rises up across 2V, comparator 182 generates a rising edge, which sets SR flip-flop 180, causing standby signal DBM to become logic “1.” At this point, secondary-side controller 104 exits no-load notification state S24 and enters deep-burst state S22 in standby mode S04. Comparator 182 equally compares output voltage V_{OUT} to 4V, a preset response value, to control SR flip-flop 180.

During deep-burst state S22, standby signal DBM disables differential amplifier OP1 and keeps switch SW2 constantly OFF. Clock generator 184, which can be considered a burst activator, is enabled and operates at a fixed clock frequency of 20 Hz, for example, generating a pulse with a 200 μs pulse width each time. These pulses activate LED current I_{OPTD} through switch SW3. As a result, the duty cycle of LED current I_{OPTD} is only 200 μs/50 ms, less than 0.5%, which is almost negligible. Thus, during deep-burst state S22, secondary-side controller 104 consumes very little power. In another embodiment, when clock generator 184 is enabled, it operates at a fixed 20 Hz frequency, generating in each cycle two consecutive pulses with a pulse width of 100 μs, separated by 1 μs between the two pulses.

When feedback voltage V_{FB} exceeds 2.75V, meaning the output voltage V_{OUT} is greater than 5.5V, or when PD controller 106 detects that load 110 is re-connected to the USB type-C interface, causing NoLoad signal to be logically “0,” escape determiner 186 resets SR flip-flop 180, stopping clock generator 184 and enabling differential amplifier OP1. Differential amplifier OP1 resumes driving switch SW2 based on the difference between feedback voltage V_{FB} and reference voltage V_{REF}. At this point, escape determiner 186 also causes PD controller 106 to set reference voltage V_{REF} to 2.5V, making target voltage V_{TAR} 5V. In other words, escape determiner 186 allows secondary-side controller 104 to exit deep-burst state S22 and enter output-voltage feedback state S20. Right after escape determiner 186 causes secondary-side controller 104 to exit deep-burst state S22, single-pulse generator 188 turns ON switch SW3 for 20 ms before turning it OFF.

In the embodiment shown in FIG. 2, secondary-side controller 104 communicates a no-load message to primary-side controller 102 by regulating output voltage V_{OUT}, and primary-side controller 102 sends a confirmation message back to secondary-side controller 104 by forcefully increasing output voltage V_{OUT}. However, the invention is not limited to this method. In other embodiments, secondary-side controller 104 can vary the value of output voltage V_{OUT} to convey messages to primary-side controller 102. For example, when secondary-side controller 104 detects that load 110 is not connected to the USB type-C interface, it can force output voltage V_{OUT} to toggle between 5V and 7V, forming a digital code that primary-side controller 102 can detect through reflected signal V_{S}. Primary-side controller 102 can then determine whether to enter a special operation mode, such as standby mode, based on this digital code. Similarly, before entering a standby mode, primary-side controller 102 could generate a digital code by controlling the output voltage V_{OUT} to send a message to secondary-side controller 104, informing it that it is about to enter a standby mode.

While the invention has been described by way of examples and in terms of preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A secondary-side controller for a power converter, the secondary-side controller comprising:
a portion of a feedback loop, configured to generate a control signal in response to a difference between an output voltage and a target voltage in a normal mode;
a load detector in response to connection of a load and the power converter for controlling the feedback loop in the normal mode, and in response to disconnection of the load from the power converter for exiting the normal mode to power down the feedback loop; and
a burst activator for switching a LED current through a photocoupler a predetermined number of times at each predetermined period during a standby mode after exiting the normal mode;
wherein the predetermined number of times is at least once.

2. The secondary-side controller of claim 1, wherein in response to the disconnection and the connection of the load the load detector sets the target voltage a first predetermined value and a normal value respectively, and the normal value is higher than the first predetermined value.

3. The secondary-side controller of claim 2, further comprising:
a comparator comparing the output voltage and a second predetermined value higher than the first predetermined value, and causing the secondary-side controller to operate in the standby mode after the output voltage exceeding the second determined value.

4. The secondary-side controller of claim 1, further comprising:
an escape determiner, for in response to the connection of the load keeping the LED current flowing through the photocoupler for a first predetermined period.

5. The secondary-side controller of claim 1, further comprising a switch connected in series with the photocoupler, wherein the burst activator turns ON the switch at least once at each predetermined period.

6. The secondary-side controller of claim 1, wherein the load detector detects a configuration channel to determine the disconnection of the load.

7. A primary-side controller in use of a power converter, comprising:
a power modulator for controlling switching cycles of a power switch in response to a compensation signal in a normal mode, and for reducing power consumption of the power modulator in a standby mode; and
a deep-burst reactor, for turning ON the power switch at least once when change of the compensation signal is detected during the standby mode;
wherein the compensation signal is controlled by a photocoupler.

8. The primary-side controller of claim 7, further comprising:
a standby detector for making the primary-side controller exit the normal mode and enter the standby mode in response to a reflected signal representing an output voltage of the power converter.

9. The primary-side controller of claim 8, wherein the standby detector makes the primary-side controller exit the normal mode when the reflected signal meets a first condition, and the primary-side controller enters the standby mode when the reflected signal meets a second condition different from the first condition.

10. The primary-side controller of claim 9, further comprising:
a periodic pulse generator for switching the power switch at a predetermined frequency after exiting the normal mode and before entering the standby mode.

11. The primary-side controller of claim 7, wherein the deep-burst reactor periodically generates pulses to turn ON and OFF the power switch until an operation voltage for the primary-side controller exceeds a predetermined value.

12. A control method for reducing standby power of a power converter with a photocoupler, comprising:
making the power converter enter a standby mode in response to disconnection of a load from the power converter; and
during the standby mode, switching a LED current through the photocoupler a predetermined number of times at each predetermined period;
wherein the predetermined number of times is at least once.

13. The control method of claim 12, further comprising:
making the power converter enter a normal mode in response to connection of the load to the power converter; and
during the normal mode, controlling the LED current based on a difference between an output voltage of the power converter and a target voltage.

14. The control method of claim 13, wherein the power converter comprises a primary-side controller and a secondary-side controller, the control method comprising:
in response to the disconnection of the load, sending a no-load message from the secondary-side controller; and
in response to receipt of a confirmation message sent from the primary-side controller, making the secondary-side controller enter the standby mode.

15. The control method of claim 13, wherein the power converter comprises a primary-side controller and a secondary-side controller, the control method comprising:
in response to receipt of a no-load message from the secondary-side controller, sending a confirmation message from the primary-side controller to the secondary-side controller; and
making the primary-side controller enter the standby mode when a reflected signal meets a predetermined condition;
wherein the reflected signal represents an output voltage of the power converter.

16. A control method for a secondary-side controller of a power converter, wherein the power converter includes a photocoupler with a LED, the control method comprising:
during a normal mode, controlling a LED current flowing through the LED based on a difference between an output voltage of the power converter and a target voltage;
in response to disconnection of a load from the power converter, regulating the output voltage to have a predetermined feature;
entering a standby mode after the output voltage loses the predetermined feature; and
switching the LED current periodically during the standby mode.

17. The control method of claim 16, comprising:
in response to the disconnection, making the output voltage less than a preset response value; and
entering the standby mode after the output voltage rises above the preset response value.

18. The control method of claim 16, wherein during the standby mode the LED current is switched at least once every predetermined period of time.

19. The control method of claim 16, wherein during the standby mode the LED current has a duty cycle less than 1%.

20. The control method of claim 16, further comprising:
exiting the standby mode to enter the normal mode when the output voltage exceeds a predetermined voltage.
